(19) United States
(12) Patent Application Publication
(10) Pub. No.: US 2010/0257462 A1
(43) Pub. Date: Oct. 7, 2010

(54) INTERPRETATION OF GESTURES TO PROVIDE VISUAL QUEUES

(75) Inventors: Karen L. Barrett, Chatswood (AU); Verna L. Iles, North Parramatta (AU); Muneyb Minhazuddin, Quakers Hill (AU); Daniel Yazbek, Five Dock (AU)

Correspondence Address: SHERIDAN ROSS P.C., 1560 BROADWAY, SUITE 1200, DENVER, CO, 80202, US

(73) Assignee: Avaya Inc, Basking Ridge, NJ (US)

(21) Appl. No.: 12/416,702

(22) Filed: Apr. 1, 2009

(51) Int. Cl. G06F 3/00

(52) U.S. Cl. 715/756

(57) ABSTRACT

The present invention provides systems, devices, and methods for obtaining, analyzing, and sharing gesture information between participants of a communication session. The present invention is particularly well suited for use in video communication sessions where participants may want to be aware of the indications that their gestures are giving to other participants. The present invention is also capable of being employed in non-video communication sessions to share gesture information and other visual indicia to other participants that cannot otherwise view the speaking/acting participant.

### FIELD OF THE INVENTION

The invention relates generally to communication systems and more particularly to the retrieval and utilization of visual queues in video communications.

### BACKGROUND

There is often a communication gap between people of different cultures. Especially during video conferences, one participant to the communication session may not be aware that their body/facial gestures are being interpreted in a certain way by other participants to the communication session. This general lack of awareness may be due to the participant not being aware that they are making certain gestures or may be due to the participant not understanding how a particular gesture they are making is interpreted in another culture.

While there have been developments in general gesture recognition, most of the existing solutions are somewhat limited. For instance, U.S. Pat. No. 6,804,396, the entire contents of which are hereby incorporated herein by reference, provides a system for recognizing gestures made by a moving subject. The system includes a sound detector for detecting sound, one or more image sensors for capturing an image of the moving subject, a human recognizer for recognizing a human being from the image captured by said one or more image sensors, and a gesture recognizer, activated when human voice is identified by said sound detector, for recognizing a gesture of the human being. The gesture recognition solution in the '396 patent, however, is relatively simple and gesture information is not used very effectively after it has been captured.

### SUMMARY

Accordingly, there exists a need for video conferencing solutions that provide gesture detection and interpretation for one or more participants and distribute such interpretative information to other participants as well as the acting participant. There is particularly a need to distribute this information to help others properly interpret gestures and to provide actors a mechanism for becoming self-aware of their gestures and actions.

These and other needs are addressed by various embodiments and configurations of the present invention. It is thus one aspect of the present invention to provide a mechanism that bridges cultural and/or communicational gaps, especially with respect to detecting and interpreting gestures conveyed during video conferencing. For example, an Australian might be on a video call to a superior in Japan. Japanese are known to have different facial expressions, so the facial expressions of the Japanese superior may be indicating something that is not being interpreted by the Australian because they are not accustomed to having those facial expressions mean anything. Embodiments of present invention provide mechanisms to address this problem.

In accordance with at least some embodiments of the present invention, a method is provided. The method generally comprises:

receiving video input of a first participant while the first participant is engaged in a communication session with at least a second participant;

analyzing the video input of the first participant for gesture information; and

providing the gesture information to at least one participant engaged in the communication session.

While gesture recognition mechanisms have been available for some time, it is believed that the information obtained from recognizing gestures has never been leveraged to enhance person-to-person communications. Particularly, utilization of gesture information to enhance communications during phone calls, video calls, instant messaging, text messaging, and the like has never been adequately employed. Emoticons have been used in text communications to allow users to type or select icons that represent their general mood, but this information is not received from analyzing the actual gestures of the user. Accordingly, the present invention provides a solution to leverage gesture information in communication sessions.

It is thus one aspect of the present invention to analyze gesture information for one or more participants in a communication session.

It is another aspect of the present invention to distribute such information to participants of the communication session. This information can be shared with other non-acting participants as well as the acting participant that is having their gestures analyzed.

It is another aspect of the present invention to determine communication and, potentially, cultural differences between communication session participants such that gesture information can be properly interpreted before it is provided to such participants. Moreover, interpretation information can be provided to the acting participant as feedback information, thereby allowing the acting participant to become self-aware of their gestures and what impact such gestures might have on other communication session participants.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram depicting a communication system in accordance with at least some embodiments of the present invention;

FIG. 2 is a block diagram depicting a communication device in accordance with at least some embodiments of the present invention;

FIG. 3 is a block diagram depicting a data structure employed in accordance with at least some embodiments of the present invention; and

FIG. 4 is a flow diagram depicting a communication method in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to monitor and report interpretations of communication session (e.g., video conference, text communication, phone call, email, etc.) participants.

The exemplary systems and methods of this invention will also be described in relation to communications software, modules, and associated communication hardware. However, to avoid unnecessarily obscuring the present invention, the following description omits well-known structures, network components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communication network and/or the Internet, or within a dedicated secure, unsecured and/or encrypted system. Thus, it should be appreciated that the components of the system can be combined into one or more devices, such as an enterprise server, a PBX, or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof. Similarly, one or more functional portions of the system could be distributed between a server, gateway, PBX, and/or associated communication device.

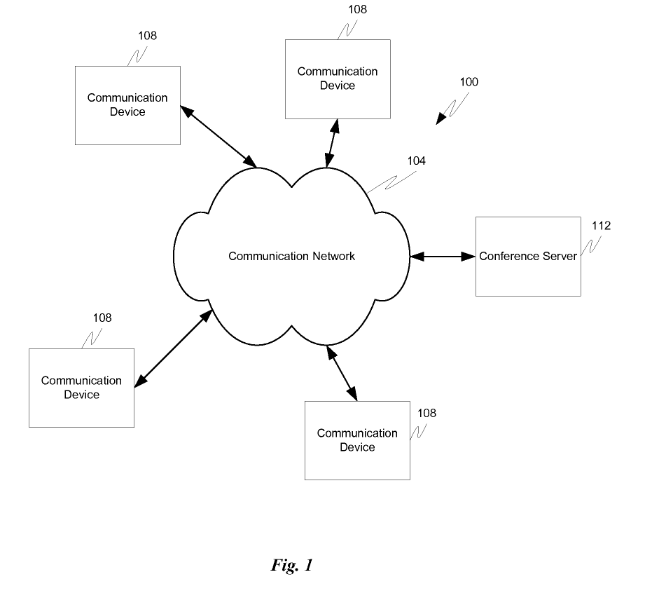

Referring initially to FIG. 1, an exemplary communication system 100 will be described in accordance with at least some embodiments of the present invention. In accordance with at least one embodiment of the present invention, a communication system 100 may comprise one or more communication devices 108 that may be in communication with one another via a communication network 104. The communication devices 108 may be any type of known communication or processing device such as a personal computer, laptop, tablet PC, Personal Digital Assistant (PDA), cellular phone, smart phone, telephone, or combinations thereof. In general, each communication device 108 may be adapted to support video, audio, text and/or other data communications with other communication devices 108.

The communication network 104 may comprise any type of information transportation medium and may use any type of protocols to transport messages between endpoints. The communication network 104 may include wired and/or wireless communication technologies. The Internet is an example of the communication network 104 that constitutes an IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, and any other type of packet-switched or circuit-switched network known in the art. In addition, it can be appreciated that the communication network 104 need not be limited to any one network type, and instead may be comprised of a number of different networks and/or network types.

The communication system 100 may also comprise a conference server 112. The conference server 112 may be provided to enable multi-party communication sessions. For instance, the conference server 112 may include a conference bridge or mixer that can be accessed by two or more communication devices 108. As an example, users of the communication devices 108 may request the services of the conference server 112 by dialing into a predetermined number supported by the conference server 112. If required, the user may also provide a password or participant code. Once the user has been authenticated with the conference server 112, that user may be allowed to connect their communication device 108 with other communication devices 108 similarly authenticated with the conference server 112.

In addition to containing general conferencing components, the conference server 112 may also comprise components adapted to analyze, interpret, and/or distribute gestures of participants to a communication session. More particularly, the conference server 112 may comprise a gesture monitoring module and/or behavioral suggestion module that allow the conference server 112 to analyze the gestures of various participants in a communication session and perform other tasks consistent with the functionality of a gesture monitoring module and/or behavioral suggestion module. The conference server 112 can be used to analyze, interpret, and/or distribute gesture information for participants communicating via the conference server 112.

Alternatively, communication session participants not using the conference server 112 (e.g., participants to a point-to-point communication session or other type of communication session not necessarily routing media through the conference server 112) may be allowed to have gesture information sent to the conference server 112 where it can be analyzed, interpreted, and/or distributed among other identified participants. In this particular embodiment, a communication device 108 not provided with the facilities to analyze, interpret, and/or distribute gesture information may still be able to leverage the conference server 112 and benefit from embodiments of the present invention.

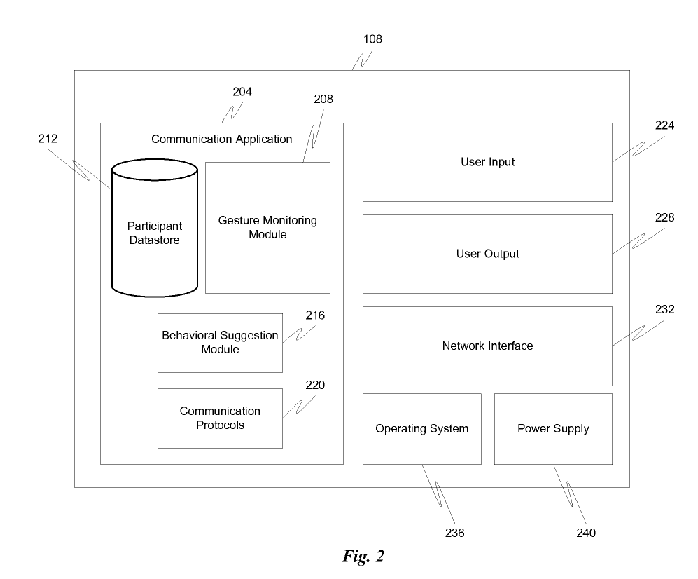

With reference now to FIG. 2, an exemplary communication device 108 will be described in accordance with at least some embodiments of the present invention. The communication device 108 may comprise one or more communication applications 204, at least one of which comprises a gesture monitoring module 208. The gesture monitoring module 208 may comprise a set of instructions stored on a computer-readable medium that are executable by a processor (not depicted). The gesture monitoring module 208 may be responsible for capturing images, usually in the form of video frames, of a user of the communication device 108. When the user is engaged in a communication session with another user (e.g., when the communication device 108 has established a connection with at least one other communication device 108 via the communication network 104), the gesture monitoring module 208 may be adapted to analyze the image information of the user. During its analysis of the image information, the gesture monitoring module 208 may interpret the gestures to obtain certain gesture information. The types of gesture information that may be obtained from the gesture monitoring module 208 include, without limitation, general mood information (e.g., happy, sad, enraged, annoyed, confused, entertained, etc.) as well as specific non-verbal communications (e.g., a message that is shared by body language and/or facial movement rather than through spoken or typed words).

The gesture monitoring module 208 may be specifically adapted to the culture of the communication device 108 user. For instance, if the user of the communication device 108 is Australian, then the gesture monitoring module 208 may be adapted to analyze the image information for certain Australian-centric gestures. Likewise, if the user of the communication device 108 is German, then the gesture monitoring module 208 may be adapted to analyze the image information for a different sub-set of gestures.

The types of gesture-recognition algorithms employed by the gesture monitoring module 208 may vary and can depend upon the processing capabilities of the communication device 108. Various examples of algorithms that may be employed by the gesture monitoring module 208 are described in one or more of U.S. Pat. Nos. 5,594,810, 6,072,494, 6,256,400, 6,393,136, and 6,804,396, each of which are incorporated herein by reference in their entirety. The algorithms employed by the gesture monitoring module 208 may include algorithms that analyze the facial movements, hand movements, body movements, etc. of a user. This information may be associated with a particular culture of the acting participant.

The communication application 204 may also be adapted to interpret/translate the gesture information for the acting participant to coincide with a culture of another participant. The communication application 204 may comprise a behavioral suggestion module 216 that is adapted to execute interpret/translate gesture information as well as share such information with participants to a communication session. In other words, the gesture monitoring module 208 may be adapted to capture image information and determine gesture information from such image information and then the behavioral suggestion module 212 may be adapted to translate the gesture information from the culture of the acting participant to a culture of another participant to the communication session. This translation may be facilitated by referencing a participant datastore 212 that maintains information regarding the culture associated with the acting participant. The participant datastore 212 may also contain information related to the cultures associated with other participants to the communication session. Information maintained in the participant datastore 212 may be developed during initialization of the communication session and may be retrieved from each participant, from their associated communication device(s), and/or from an enterprise database containing such information.

As an example, the behavioral suggestion module 2162 may be capable of mapping a meaning of the gesture information in one culture to a meaning of the gesture information in another culture. This is particularly useful when the acting participant and viewing/listening participant are associated with significantly different cultures. In these circumstances, each participant may not appreciate that their gestures are conveying a certain meaning to the other participant. The present invention may leverage the behavioral suggestion module 216 to determine the multiple meanings a particular gesture may have and share such meanings with one, both, a subset, or all participants. Thus, the acting participant may be made aware of the non-verbal communications they are sending to their audience and the audience may be aware of what is intended by such non-verbal communications.

In accordance with at least some embodiments of the present invention, the interpretation of gesture information may be obtained automatically by the behavioral suggestion module 216. Alternatively, or in addition, the behavioral suggestion module 216 may be adapted to query the acting participant to determine whether they are aware of their non-verbal messages and/or if they want to convey such messages (or other messages) to the other participants in the communication session. For example, if an acting participant is moving in such a way that their gestures suggest they are angry, the behavioral suggestion module 216 may identify these gestures and the possible meaning of such gestures. The behavioral suggestion module 216 may then ask the acting participant if they are intending to disseminate this message to the other participants or whether there is any other message the acting participant wants to convey to the other participants. If the user answers affirmatively that they want to share such a message, then the gesture information initially identified by the gesture monitoring module 208 may shared with the other participants. If the acting participant alters the message that is to be shard with the other participant, then the gesture monitoring module 208 may alter the gesture information that is shared with the other participants in accordance with the acting participant's input.

In addition to containing modules for analyzing, interpreting, and/or sharing gesture information among communication session participants, the communication application 204 also includes communication protocols 220 that are used by the communication application 204 to enable communications across the communication network 104 with other communication devices 108.

The communication device 108 may further include a user input 224, a user output 228, a network interface 232, an operating system 236, and a power supply 240. The operating system 236 is generally a lower-level application that enables navigation and use of the communication application 204 and other applications residing on the communication device 108.

The power supply 240 may correspond to an internal power source such as a battery or the like. Alternatively, or in addition, the power supply 240 may comprise a power converter that is adapted to convert AC power received from a power outlet into DC power that can be used by the communication device 108.

The network interface 232 may include, but is not limited to, a network interface card, a modem, a wired telephony port, a serial or parallel data port, radio frequency broadcast transceiver, a USB port, or other wired or wireless communication network interfaces.

The user input 224 may include, for example, a keyboard, a numeric keypad, and pointing device (e.g., mouse, touch-pad, roller ball, etc.) combined with a screen or other position encoder. Furthermore, the user input 224 may comprise mechanisms for capturing images of a user. More specifically, the user input 224 may comprise a camera or some other type of video capturing device that is adapted to capture a series of images of the user. This information may be provided as an input to the gesture monitoring module 208.

Examples of user output devices 228 include an alphanumeric display, a Liquid Crystal Display (LCD), a Light Emitting Diode (LED), a plasma display, a Cathode Ray Tube (CRT) screen, a ringer, and/or indicator lights. In accordance with at least some embodiments of the present invention, a combined user input/output device may be provided, such as a touch-screen device.

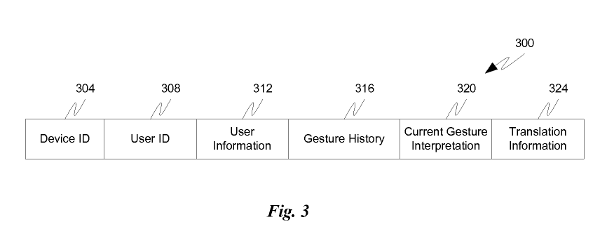

With reference now to FIG. 3, an exemplary data structure 300 will be described in accordance with at least some embodiments of the present invention. The data structure 300 may include a number of data fields for storing information used in analyzing and interpreting gesture information. The data structure 300 may be maintained on the datastore 212 or any other data storage location, such as an enterprise database. The data structure 300 may be maintained for the duration of the communication session or longer periods of time. For example, some portions of the data structure 300 may be maintained after a communication session has ended.

The types of fields that may be included in the data structure 300 include, without limitation, a device identifier field 304, a user identifier field 308, a user information field 312, a gesture history field 316, a current gesture interpretation field 320, and a translation information field 324. The device identifier field 304 and user identifier field 308 may be used to store device identification information and user identification information, respectively. Examples of device identifiers stored in the device identifier field 304 may include an Internet Protocol (IP) address, a Media Access Control (MAC) address, a Universal Resource Identifier (URI), a phone number, an extension, or any other mechanism for identifying communication devices 108. Likewise, the user identifier may include a name of the user associated with a particular communication device 108. As can be appreciated by one skilled in the art, multiple users may be associated with a single communication device 108 (e.g., during a conference call where one conferencing communication device 108 is located in a room with multiple participants).

For each user identified in the user identification field 308, the user's information may be stored in the user information field 312. More specifically, if a user is associated with one or more cultures, then that information may be maintained in the user information field 312. For example, the user information field 312 may store cultural information for each user and may further comprise information used to translate gesture information between the users in a communication session.

The gesture history filed 316 may comprise information related to the previous gestures of a communication session participant. This historical gesture information may be leveraged to identify future gesture information for a particular user. Furthermore, the historical gesture information may include the user's responses to queries generated by the behavioral suggestion module 216. All of this information may be useful in analyzing future gesture information for that user as well as determining whether an interpretation of their gesture information is necessary.

The current gesture interpretation field 320 may comprise information related to the current analysis of the user's actions. More specifically, the current gesture interpretation field 320 may store analysis results obtained from the gesture monitoring module's 208 during a communication session.

The translation information field 324 may comprise translation information related to the currently analysis of the user's actions. Moreover, the translation information field 324 may comprise information that is used to map the meaning of gesture information from one culture to another culture. Thus, the translation information field 324 may store interpretation results obtained from the behavioral suggestion module 216 during a communication session as well as information used by the behavioral suggestion module 216 to obtain such translation information.

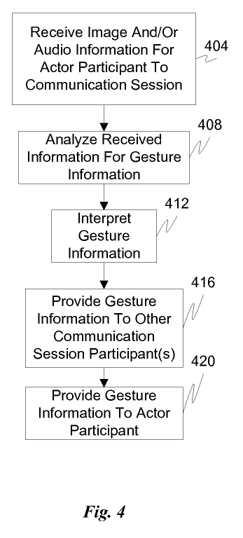

Referring now to FIG. 4, an exemplary communication method will be described in accordance with at least some embodiments of the present invention. The method may be employed in any communication session between two or more participants communicating with one another over a communication network 104. For example, the communication session may comprise a telephonic conference or video conference where the communication devices 108 establish a voice/data path between one another through the communication network 104. As another example, the communication session may comprise a text-based communication session (e.g., email-based communication session, IM session, SMS session, or the like) where one user sends a text message to another user via the communication network 104. The generation of a text message may initiate the instantiation of the communication method depicted in FIG. 4, thereby triggering the collection, analysis, and possible interpretation of gesture information from the sending user and including such gesture information in the message before it is sent to the target recipient(s).

The communication method is initiated by capturing image and/or audio information from an acting participant during a communication session (or during preparation of a text-based message during a text-based communication session) (step 404). The nature and amount of image and/or audio information captured may depend upon the cultural differences between participants. As one example, a significant cultural difference, such as between Japanese and Canadian participants, may justify a need to capture more gesture information since more interpretation may be required, whereas a lesser cultural difference, such as between American and Canadian participants, may not require as much interpretation and, therefore, may not necessitate capturing as much image and/or audio information.

After the appropriate amount and type of information is captured from the acting participant, the method continues with the gesture monitoring module 208 analyzing the received information for gesture information (step 408). The gesture monitoring module 208 may obtain more than one type of gesture information from a particular set of data. For example, the gesture monitoring module 208 may determine that the acting participant is conveying a particular mood (e.g., confusion) as well as a non-verbal message (e.g., “I don't understand. Please repeat.”). Accordingly, both types of gesture information may be associated with the captured information as well as the acting participant.

The gesture information may then be passed to the behavioral suggestion module 216 where the gesture information is interpreted (step 412). The interpretations made may vary depending upon the cultural differences between communication session participants. Thus, if the communication session comprises three or more participants each being associated with a different culture, then the behavioral suggestion module 216 may prepare two or more interpretations of the gesture information.

The interpretation of the gesture information, and possibly the original gesture information, may then be provided to other communication session participant(s) (step 416). This information may be shared with other users by including such information in the message itself or by sending such information separate from the message. This interpretation information is then provided to the other participant via their communication device 108. The information may be provided in an audible and/or visual format. As an example, the information may be provided to the other participants via a whisper page or some other separate communication channel. As another example, the information may be provided to the other participants via an icon and/or text message that displays the gesture information and/or interpretation thereof.

Likewise, the interpretation(s) of the gesture information may be provided back to the acting participant (step 420). This allows the acting participant to become aware of the interpretation information that has been shared with the other participants. Moreover, this feedback allows the acting participant to determine whether they are conveying something they want to convey non-verbally or whether they are accidentally conveying something they do not want to convey. The feedback information may be provided as an audible and/or visual message in a similar fashion to the way that such information was provided to the other participants.

This method may continue to be executed until the communication session has ended. As can be appreciated by one skilled in the art, however, gesture information obtained from one communication session may be stored and used in subsequent communication sessions. For example, a participant's cultural information may be maintained in a contact log such that it can be accessed by the gesture monitoring module 208 and/or behavioral suggestion module 216 during later communication sessions.

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for allowing communications enabled devices to socialize with one another and establish a shared functionality. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
receiving video input of a first participant while the first participant is engaged in a communication session with at least a second participant;
analyzing the video input of the first participant for gesture information; and
providing the gesture information to at least one participant engaged in the communication session.

2. The method of claim 1, further comprising:
interpreting the gesture information based on a known culture of the at least a second participant; and
associating the interpretation of the gesture information with the gesture information.

3. The method of claim 2, further comprising providing the gesture information and the interpretation of the gesture information to the first participant.

4. The method of claim 3, wherein the interpretation of the gesture information is provided to the first participant via a graphical user interface associated with the first participant.

5. The method of claim 3, wherein the interpretation of the gesture information is provided to the first participant via an audible mechanism.

6. The method of claim 2, wherein interpreting comprises:
determining a culture associated with the at least a second participant;
mapping the gesture information received from the video input with selected gesture information for the culture associated with the at least a second participant; and
wherein the interpretation of the gesture information comprises the mapping information and the selected gesture information.

7. The method of claim 1, further comprising:
determining a possible meaning of the gesture information based on a known culture of the first participant;
associating the possible meaning of the gesture information with the gesture information; and
providing the gesture information and the possible meaning of the gesture information to the at least a second participant.

8. The method of claim 7, wherein determining a the possible meaning of the gesture information comprises:
determining a culture associated with the first participant;
mapping the gesture information received from the video input with selected gesture information for the culture associated with the first participant; and
wherein the interpretation of the gesture information comprises the mapping information and the selected gesture information.

9. The method of claim 7, wherein determining a the possible meaning of the gesture information comprises:
querying the first user for an intended meaning of their gesture;
receiving a response to the query from the first user; and
including at least a portion of the response in the possible meaning of the gesture information.

10. A computer readable storage medium comprising processor executable instruction operable to perform, when execute, the method of claim 1.

11. A communication device, comprising:
a user input operable to capture video images of a first participant during a communication session with at least a second participant; and
a gesture monitoring module operable to analyze the captured video images of the first participant for gesture information and provide the gesture information to at least one participant of the communication session.

12. The device of claim 11, further comprising a behavioral suggestion module operable to interpret the gesture information based on a known culture of the at least a second participant and associate the interpretation of the gesture information with the gesture information.

13. The device of claim 12, further comprising a user output operable to provide the gesture information and the interpretation of the gesture information to the first participant.

14. The device of claim 13, wherein the user output comprises at least one of a graphical user interface and an audible user interface.

15. The device of claim 12, further comprising a participant datastore, wherein the behavioral suggestion module is operable to reference the participant datastore to determine a culture associated with the at least a second participant and then map the gesture information received from the video images with selected gesture information for the culture associated with the at least a second participant and then include the mapping information and the selected gesture information in the interpretation of the gesture information.

16. The device of claim 11, further comprising a behavioral suggestion module operable to determine a possible meaning of the gesture information based on a known culture of the first participant, associate the possible meaning of the gesture information with the gesture information, and then provide the gesture information and the possible meaning of the gesture information to the at least a second participant.

17. The device of claim 16, comprising a participant datastore, wherein the behavioral suggestion module is operable to reference the participant datastore to determine a culture associated with the first participant, map the gesture information received from the video input with selected gesture information for the culture associated with the first participant, and include the mapping information and the selected gesture information in the interpretation of the gesture information.

18. The device of claim 17, wherein the behavioral suggestion module is operable to determine a possible meaning of the gesture information by preparing and sending a query to the first user for an intended meaning of their gesture, receive a response to the query from the first user, and then include at least a portion of the response in the possible meaning of the gesture information.

19. A communication system including a first communication device in communication with a second communication device via a communication network, the communication system comprising:
a communication application operable to capture video images of a first participant associated with the first communication device during a communication session with at least a second participant, analyze the captured video images of the first participant for gesture information and provide the gesture information to at least one participant of the communication session.

20. The system of claim 19, wherein the communication application is further operable to interpret the gesture information based on a known culture of the at least a second participant and associate the interpretation of the gesture information with the gesture information and provide the gesture information and the interpretation of the gesture information to the first participant.

21. The system of claim 19, wherein the communication application is further operable to determine a possible meaning of the gesture information based on a known culture of the first participant, associate the possible meaning of the gesture information with the gesture information, and then provide the gesture information and the possible meaning of the gesture information to the at least a second participant.
